(19) United States
(12) Patent Application Publication
(10) Pub. No.: US 2006/0069627 A1
(43) Pub. Date: Mar. 30, 2006

(54) Gift registry system

(76) Inventors: Laurel Petersen, Whitewater, WI (US); Darlene Bernarde, Cottage Grove, WI (US)

Correspondence Address: KOLISCH HARTWELL, P.C., 200 PACIFIC BUILDING, 520 SW YAMHILL STREET, PORTLAND, OR, 97204, US

(21) Appl. No.: 11/233,935

(22) Filed: Sep. 23, 2005

Related U.S. Application Data
(60) Provisional application No. 60/612,912, filed on Sep. 24, 2004.

(51) Int. Cl. G06F 17/30; G07F 7/00

(52) U.S. Cl. 705/27

(57) ABSTRACT

A registry system for creating a gift register. The registry system includes a storage device and a processor. The storage device includes an application with instructions to: (1) create a wish list that includes one or more items selected by a first person and a first identifying code; (2) store the wish list on the storage device; (3) transmit the wish list to a second person upon a command by the first person; (4) create a gift register that includes one or more items selected from the wish list by the second person, and one or more pieces of identifying information; (5) store the gift register on the storage device; and (6) maintain a searchable database that enables a third person to access the wish list by providing the first identifying code, and to access the gift register by providing a sufficient amount of the identifying information. The processor executes the instructions.

### CROSS-REFERENCE TO RELATED APPLICATION

This application claims priority under 35 U.S.C. § 119(e) to U.S. Provisional Patent Application Ser. No. 60/612,912 entitled “Gift Registry System,” filed Sep. 24, 2004, the complete disclosure of which is herein incorporated by reference for all purposes.

### BACKGROUND

A typical consumer purchases gifts for others in connection with a wide variety of events, such as weddings, baby showers, birthdays, etc. The person or people for whom gifts are to be purchased sometimes provide a list of desired items to potential gift purchasers, to ensure that they will enjoy the gifts they receive. These desired items may be sold at one or more stores. As the number of gift purchasers increases, the likelihood that a duplicate gift is purchased increases.

In order to alleviate this problem, many retailers provide gift registry systems. Typical gift registry systems enable registrants to create and manage gift registers having a list of items the registrant would like to receive, and one or more pieces of identifying information. These gift registers may be created by the registrant either at the retailer's store or through the retailer's online website. Generally, anyone can create a gift register online, regardless of their age or mental capacity. Gift registers may be transmitted to potential gift purchasers, or may be stored in a searchable database. Gift purchasers may thereafter search the database in order to access a particular registrant's gift register, thereby ensuring they will purchase a gift the registrant would like to receive, and reducing the amount of time spent shopping. Gift registry systems are generally configured to keep track of purchases made by gift purchasers from a particular gift register, thereby enabling the registrant to observe which gifts have already been purchased, and to prevent subsequent gift purchasers from purchasing duplicate gifts.

As indicated above, gift registers generally include a list of items the registrant would like to receive, as well as one or more pieces of identifying information. Usually, the identifying information includes some personal information of the registrant, such as their name, address, telephone number, etc. Some gift registers also include additional information, such as the date of a particular event (wedding, baby shower, birthday, etc.), or a unique identifying code. This additional information may ensure that multiple gift registers, particularly those having registrants with the same name and place of residence, do not have an identical set of identifying information.

In order to search for and access a particular registrant's gift register stored in existing gift registry systems, gift purchasers generally only have to provide a limited amount of personal information. For example, some gift registry systems include in-store kiosks or online websites that enable third parties to enter one or more pieces of search information (such as a registrant's name, address, phone number, etc.), after which the gift registry system displays a list of all the gift registers having common identifying information that matches the search information. Any gift register on the list may be accessed by the third party, and upon accessing a particular gift register, additional information about the corresponding registrant is often displayed, without having been provided by the third party during the initial search. While this mechanism for accessing gift registers enables third parties to find and access the gift register of the correct registrant, it also fails to adequately secure the personal information of the other registrants identified by the search.

Because many gift registry systems allow anyone to create a gift register, regardless of age or mental capacity, children/dependents may be able to create gift registers without the knowledge or supervision of their parents/guardians. These gift registers may include some of the child's/dependent's personal information, which in turn may be accessed by any third party. Further, parents/guardians do not have any control over the items selected by their child/dependent, thereby creating a potential for the child/dependent to receive gifts deemed undesirable by the parents/guardians.

The present disclosure includes substantial improvements, including a gift registry system that: (1) enables children/dependents to indicate the items they would like to receive as gifts; (2) enables parents/guardians to create a gift register on behalf of their child/dependent, whereby parents/guardians control the inclusion of any identifying personal information, and items they would like their child/dependent to receive; and (3) adequately secures the personal information of the child/dependent from third parties.

Examples of gift registry systems may be found in U.S. Pat. Nos. 6,793,130; 6,785,824; 6,676,014; 6,669,088; 6,618,753; 6,611,814; 6,609,106; 6,587,835; 6,556,975; 6,493,742; 6,490,602; 6,360,254; 6,343,274; 6,101,483; 5,970,474; 5,939,695; 5,898,594; 5,774,874; 5,754,981; 5,710,887; 5,652,421; and 5,513,117; U.S. Patent Application Nos. 2004/0158500; 2004/0039649; 2003/0233283; 2003/0154135; 2003/0093333; 2003/0074265; 2003/0036973; 2002/0194087; 2002/0184104; 2002/0111875; 2002/0077929; 2002/0072974; 2001/0054009; 2001/0049637; 2001/0049636; and 2001/0044751; and PCT Application Nos. WO 04/013736; WO 03/042887; WO 02/07042, WO 01/80133; WO 01/35186; WO 00/42550; and WO 00/39738, the entire disclosures of which are herein incorporated by reference for all purposes.

### BRIEF DESCRIPTION OF THE DRAWINGS

FIG. 1 is a block diagram of a gift registry system gaming system according to the present disclosure.

FIG. 2 is a flow chart showing the processes performed by an application of the gift registry system of FIG. 1.

FIG. 3 is a flow chart showing the process of accessing a gift register.

### DETAILED DESCRIPTION

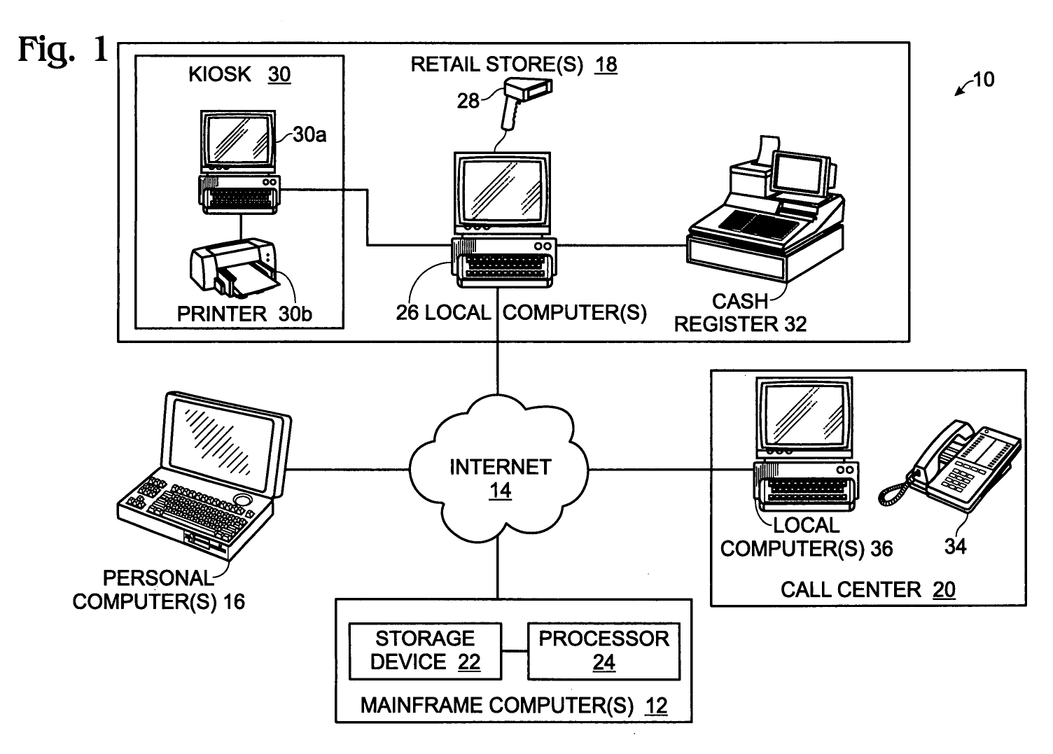

FIG. 1 shows a gift registry system 10 for creating, storing, transmitting, modifying and providing access to gift registers. The gift registry system may include mainframe computer(s) 12 connected to remote servers via the internet 14. These remote servers may include personal computer(s) 16, retail store(s) 18, and/or a call center 20.

Mainframe Computer(s) 12 may include a storage device 22 and a processor 24. The storage device may be configured to store data, such as network and web-based software applications for creating, storing, transmitting, modifying and providing access to gift registers. The storage device may also be configured to store files created and/or modified by the software applications. The processor may be configured to execute the software applications stored on the storage device.

Personal computer(s) 16 that are connected to the internet 14 may enable users to remotely access aspects of the applications stored in the mainframe computer(s) 12, such as via a website. As described in more detail below, accessing the application from a personal computer connected to the internet may enable: (1) registrants to create, store, transmit, and modify gift registers; and (2) third parties (e.g. customers, purchasers, etc.) to access a registrant's gift register in order to purchase gifts for the registrant. Online purchases may automatically update gift registers stored in the storage device of the mainframe computer to reflect that the item has been purchased, thereby preventing duplicate purchases.

Retail store(s) 18 that are connected to the internet 14 may include local computer(s) 26, handheld scanners 28, a kiosk 30, and a cash register 32. The local computer(s) may be configured to remotely access software applications stored on the mainframe computer(s) 12 via the internet 14. As described in more detail below, accessing the application from local computer(s) connected to the internet may enable: (1) registrants to create, store, transmit, and modify gift registers with the help of a local sales representative; and (2) third parties (e.g. customers, purchasers, and/or sales representatives) to access a registrant's gift register in order to purchase gifts for the registrant. The handheld scanners 28 may be configured to scan and store product information of products that a registrant would like to add to their gift register. The information may be downloaded from the handheld scanners to the local computer(s), whereby the software applications may be used to create a gift register. The kiosk 30 may include a computer 30a and a printer 30b for enabling a customer to access and print a gift register without the assistance of a sales representative. The cash register 32 may enable customers to purchase items from a gift register. The cash register may be connected to the local computer(s), and may be configured to automatically update gift registers stored in the storage device of the mainframe computer to reflect that the item has been purchased, thereby preventing duplicate purchases.

Call center 20 may enable registrants and customers to phone a call representative having access to the software application stored on the mainframe computer. The call center may include telephone(s) 34 and local computer(s) 36. The telephone(s) may be manned by call representative(s) that receive calls from customers and/or registrants. The local computer(s) may be connected to the internet 14, and may enable the call representative(s) to remotely access aspects of the application stored in the mainframe computer(s) 12, such as via a website. As described in more detail below, accessing the application from the local computer(s) may enable call representatives to: (1) create, store, transmit, and modify a registrant's gift register on behalf of the registrant; and (2) access a registrant's gift register on behalf of a third party, thereby enabling the third party to order an item from the gift register. These purchases may automatically update gift register to reflect that the item has been purchased, thereby preventing duplicate purchases.

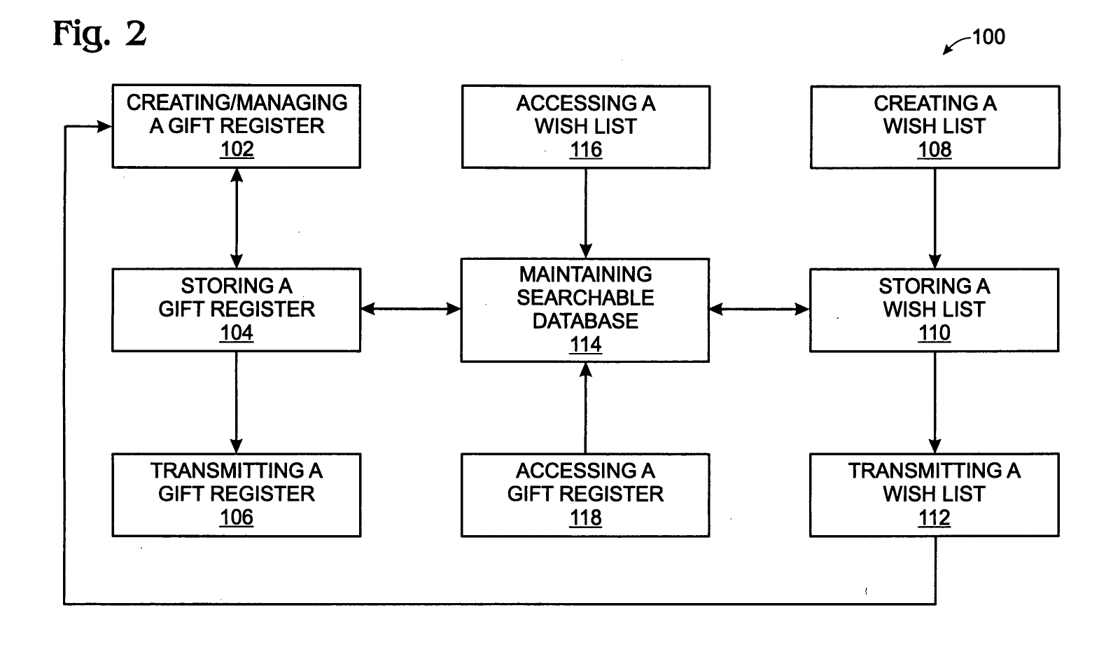

FIG. 2 is a flow chart showing the processes performed by an application 100 of the gift registry system 10 of FIG. 1. The software application may be stored on a storage device 22 and executed by processor 24. As shown in FIG. 2, the application may include instructions executable via the internet, for: creating and/or managing a gift register on behalf of a child/dependant registrant 102; storing the gift register on the storage device 104; transmitting the gift register 106; creating a wish list for a child/dependant registrant 108; storing the wish list 110; transmitting the wish list 112; and maintaining a searchable database 114. While the software application is described as enabling a parent/guardian to create, store, transmit, modify and provide access to a gift register on behalf of a child/dependant, the software application may also enable a first person to create, store, transmit, modify and provide access to a gift register on behalf of a second person.

The software application 100 may include one or more modes that enable a parent/guardian to create a gift register 102 on behalf of a child/dependant. Specifically, some modes: may enable the parent/guardian to select one or more items they would like the child/dependant to receive from one or more purchasers; may prompt the parent/guardian to associate the list of items with one or more pieces of identifying information; may be configured to prevent minors from creating a gift register.

Some modes that enable a parent/guardian to create a gift register 102 may do so by enabling the parent/guardian to select one or more items they would like the child/dependant to receive from one or more purchasers. For example, some modes may enable the parent/guardian to select items: (1) via a website having an online catalog; (2) at a retail store by using a scanner or by instructing a sales representative to enter items into the register on their behalf; and/or (3) via a call center by instructing a call center representative to enter items into the register on their behalf. Some modes may enable the parent/guardian to select one or more items from a wish list created by the child/dependant (as discussed below) and to import the selected items into the gift register.

Some modes that enable a parent/guardian to create a gift register 102 may do so by prompting the parent/guardian to associate the list of selected items with one or more pieces of identifying information. For example, the identifying information may include: (1) a parent's/guardian's login name and password for allowing the parent/guardian to access and modify the gift register; (2) one or more pieces of personal information about the child/dependant for allowing third parties to search for and access the gift register; (3) an identifying code created by the software application that uniquely identifies the gift register for allowing third parties to search for and access the gift register; and/or (4) a third party access password selected by the parent/guardian for preventing unauthorized third parties from accessing the gift register.

Some modes that enable a parent/guardian to create a gift register 102 may be configured to prevent minors from creating a gift register. For example, the mode may require any user attempting to create a gift register to enter their age, whereby minors are prevented from accessing other modes that enable the creation of a gift register.

The software application 100 may include one or more modes that enable a parent/guardian to manage a gift register 102 on behalf of a child/dependant. Specifically, some modes: may enable the parent/guardian to access and modify the gift register's list of items; may be configured to provide an indication that an item has been purchased off of the gift register; may be configured to prevent minors from modifying a gift register.

Some modes that enable a parent/guardian to manage a gift register 102 may do so by enabling the parent/guardian to access and modify the gift register's list of items. Specifically, the parent/guardian may be able to access the gift register and: (1) add newly selected items to add to the list; (2) remove items from the list; (3) import new items from a wish list of the child/dependant; and/or (4) modify the identifying information associated with the list. The parent/guardian may access the gift register for modification via a website, at a retail store, or via a call center by instructing a call center representative to modify the items in the register. To ensure that a user attempting to modify the gift register is the parent/guardian, the user may be required to enter/provide the parent's/guardian's login name and password.

Some modes that enable a parent/guardian to manage a gift register 102 may be configured to receive an indication that an item has been purchased off of the gift register, and to update the gift register to reflect that the item has been purchased, thereby preventing duplicate purchases. The indication may be automatic as the result of a third party purchasing an item via a website, at a retail store, or via a call center. The indication may also be manually entered by a parent/guardian.

Some modes that enable a parent/guardian to manage a gift register 102 may be configured to prevent minors from modifying a gift register. For example, the modes may require users attempting to modify a gift register to enter their age, whereby minors are prevented from accessing other modes that enable the modification of a gift register.

The software application 100 may include one or more modes that enable a parent/guardian to store their child's/dependant's gift register on the storage device, as indicated at 104. The stored file may include the original or modified list of items selected by the parent/guardian, and the associated identifying information entered by the parent/guardian. These saved gift registers may be modified by parents/guardians as described above, and may be accessed by third parties as described below. Some modes may automatically delete the gift register from the storage device if it remains inactive (i.e. no one accesses or modifies the gift register) for a specified amount of time (e.g. one year).

The software application 100 may include one or more modes that enable a parent/guardian to transmit portions of their child's/dependant's gift register to third parties 106. This transmission may occur via electronic mail. The portions of the gift register transmitted to the third party may include the list of items currently saved on the storage device, along with any indications reflecting which of the items have or have not been purchased. The portions of the gift register transmitted to the third party may also include one or more pieces of the identifying information associated with the list of items. For example the transmitted portions may include: (1) one or more pieces of the child/dependant's personal information (i.e. name, address, etc.); (2) the identifying code created by the software application that uniquely identifies the gift register; and/or (3) the third party access password selected by the parent/guardian. By transmitting this identifying information, the parent/guardian ensures that the third party has adequate information to access the gift register via a website, at a retail store, or via a call center. The parent/guardian is thereby authorizing the third party to access their child's/dependant's gift register

The software application 100 may include one or more modes that enable a child/dependant to create a wish list 108 for themselves. Some modes may enable the child/dependant to select one or more items they would like to receive from one or more purchasers. For example, the child/dependant may select items: (1) via a website having an online catalog; (2) at a retail store with the help of a sales representative; and/or (3) via a call center by instructing a call center representative to enter items into the register on their behalf. Some modes may create and associate a unique identifying code with the wish list. This code may allow a user to access the wish list as described below. Finally, some modes may be configured to prevent the child/dependant from associating any personal information with the gift register. These modes thereby ensure that only parents/guardians enter their child's/dependant's personal information into the gift registry system.

The software application 100 may include one or more modes that enable a child/dependant to store their wish list on the storage device, as indicated at 110. The stored file may include the list of items selected by the child/dependant, and the unique identifying code. Some modes may automatically delete the gift register from the storage device if it remains inactive (i.e. no one accesses the wish list) for a specified amount of time (e.g. 30 days).

The software application 100 may include one or more modes that enable a child/dependant to transmit their wish list 112 to their parents/guardians and to third parties, such as friends and relatives. This transmission may occur via electronic mail. The transmission may include the list of wish list items saved on the storage device. The transmission may also include the unique identifying code created by the software application. As described above, parents/guardians receiving a transmitted wish list may select items from the wish list to import into a gift register. For example, the parent/guardian may enter a mode for importing items from a wish list, whereby the mode may prompt the parent/guardian to enter the unique identifying code associated with their child's/dependant's wish list. The software application may then provide a mode whereby the parent/guardian selects the items from the wish list that they would like their child/dependant to receive, and import the selected items into a gift register. This ensures that only items authorized by the parent/guardian are included in a gift register accessible by third parties.

The software application 100 may include one or more modes for maintaining a searchable database 114. The database may organize wish lists and gift registers based on their identifying information, and may include modes that enable third parties to search for and access wish lists 116 and gift registers 118 based on their identifying information.

Some modes may enable a third party to search for and access a wish list 116 based on its unique identifying code. Search modes may be accessed by any third party wanting to view a child's/dependent's wish list, such as a customer/purchaser, or a retail store sales representative or call center sales representatives on behalf of a customer/purchaser. The third party may be prompted to enter an identifying code, after which the software application may search the searchable database for a wish list corresponding to the entered code. If the child/dependent or parent/guardian has provided the third party with a valid code (e.g. via an electronic mail transmission), the wish list will be accessed and presented to the third party.

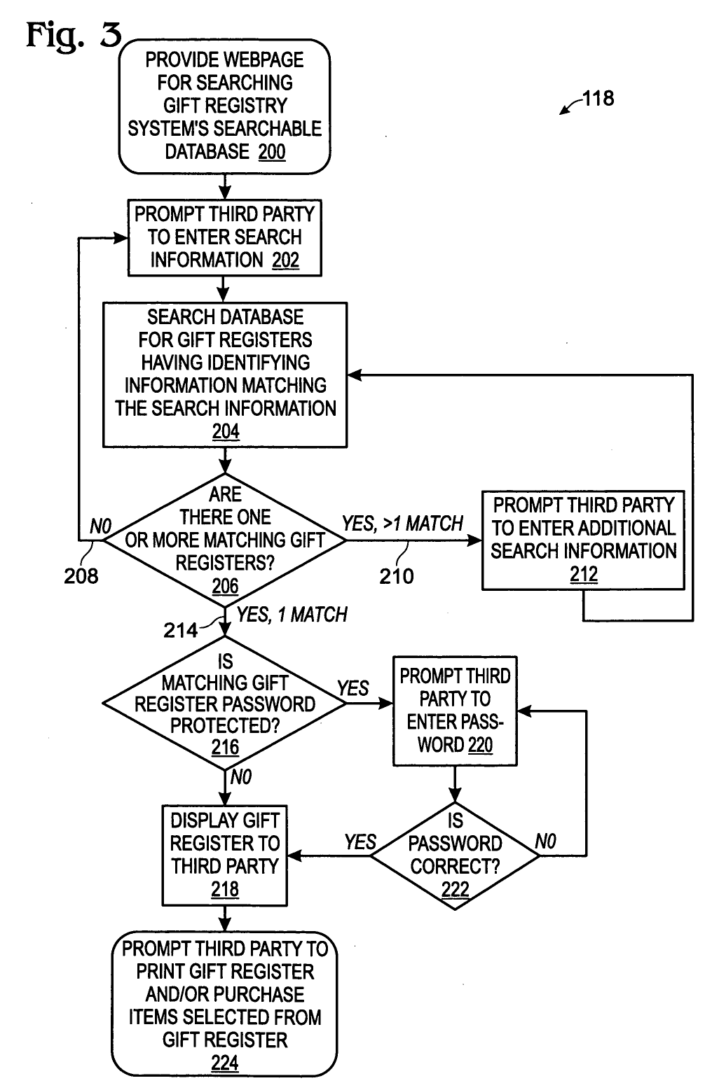

The software application 100 may include one or more modes that enable a third party to search for a gift register 118 based on its identifying information. For example, as shown in FIG. 3, some modes may provide a webpage for searching a gift registry system's searchable database 200. The webpage may be accessed by any third party wanting to view a child's/dependent's gift register, such as a customer/purchaser, or a retail store sales representative or call center sales representatives on behalf of a customer/purchaser. The webpage may prompt the third party to enter one or more pieces of search information 202 in one or more search fields, such as (1) one or more pieces of the registrant's personal information (i.e. name, place of residence, address, age, telephone number, etc.); or (2) the unique identifying code associated with the gift register. The third party may be required to enter search information for some of the fields (e.g. name, and place of residence), without being required to enter search information for all of the fields (e.g. address, age, telephone number, or the unique identifying code). The software application may then be configured to search the searchable database for gift registers having identifying information that matches the search information 204, and to determine whether there are one or more matching gift registers 206.

The software application 100 may include one or more modes that conditionally enable a third party to access a gift register 118. Specifically, these modes may be configured to provide the third party with access to a matching gift register provided sufficient search information was entered by the purchaser to uniquely identify a single gift register from the plurality of gift registers maintained in the searchable database. For example, if a third party provides search information that does not match the identifying information of any gift registers 208, the application may be configured to re-prompt the third party to enter search information 202. If the provided search information matches the identifying information of more than one gift register 210, the application may be configured to prompt the third party to enter additional search information 212 (e.g. the registrant's address or age, telephone number, or the unique identifying code) that was not entered in the original search, without providing the third party with any information associated with any of the matching gift registers. If the third party is still unable to provide sufficient search information to identify a single register, the customer may be required to contact the parent/guardian to obtain sufficient search information (e.g. the unique identifying code). However, if the provided search information matches the identifying information of a single gift register 214, then the software application may be configured to determine whether the third party is authorized to access the matching gift register, as described below.

As discussed above, the software application may enable parents/guardians to prevent unauthorized third parties from accessing matching gift registers by associating the gift register with a third party access password. If a third party has provided sufficient search information to identify a single gift register from the plurality of gift registers maintained in the searchable database 214, then the software application may be configured to determine whether the matching gift register is password protected 216. If the matching gift register is not password protected, then the application may be configured to provide access to the gift register by displaying it to the third party 218. If the matching gift register is password protected, then the application may be configured to prompt the third party to enter a password 220, and to determine whether the correct password has been entered 222. If the third party enters the incorrect password, then the application may be configured to re-prompt the third party to enter the password 220. However, if the third party enters the correct password, then the application may be configured to provide access to the gift register by displaying it to the third party 218. After the third party has obtained access to the matching gift register 216, the application may be configured to prompt the third party to print the gift register and/or electronically purchase items selected from the gift register 224.

As discussed above, items purchased from the gift register may be marked, so that duplicate gifts are not purchased for the registrant. E.g., if the gift register is printed at a store kiosk, and an item is selected from the shelves and purchased at a cash register, the local computers connected to the cash register may automatically mark the gift register to indicate that the item has been purchased. Likewise, if an item is purchased via the internet, such as at home or through a call representative at a call center, then the application may automatically mark the gift register to reflect the internet purchase.

It is believed that this disclosure encompasses multiple distinct inventions with independent utility. While each of these inventions has been described in its best mode, numerous variations are contemplated. All novel and non-obvious combinations and subcombinations of the described and/or illustrated elements, features, functions, and properties should be recognized as being included within the scope of this disclosure. Applicant reserves the right to claim one or more of the inventions in any application related to this disclosure. Where the disclosure or claims recite “a,” “a first,” or “another” element, or the equivalent thereof, they should be interpreted to include one or more such elements, neither requiring nor excluding two or more such elements.

We claim:

1. A registry system for creating a gift register, comprising;
a storage device including an application having instructions to:
create a wish list that includes:
one or more items selected by a first person; and
a first identifying code;
store the wish list on the storage device;
transmit the wish list to a second person upon a command by the first person;
create a gift register that includes:
one or more items selected from the wish list by the second person; and
one or more pieces of identifying information;
store the gift register on the storage device; and
maintain a searchable database that enables a third person to access:
the wish list by providing the first identifying code; and
the gift register by providing a sufficient amount of the identifying information; and
a processor that executes the instructions.

2. The registry system of claim 1, wherein the instructions are executable via the internet.

3. The registry system of claim 1, wherein the application further has instructions to provide a website having a plurality of selectable items.

4. The registry system of claim 1, wherein the application further has instructions to automatically delete the wish list from the storage device after a predetermined amount of time.

5. The registry system of claim 1, wherein the instructions transmit the wish list by electronic mail.

6. The registry system of claim 1, wherein the gift register further includes one or more additional items, selected by the second person, which are unrelated to the one or more items included in the wish list.

7. The registry system of claim 1, wherein the one or more pieces of identifying information include:
one or more pieces of the first person's personal information as provided by the second person; and
a second identifying code that uniquely identifies the gift register.

8. The registry system of claim 1, wherein the gift register further includes a password selected by the second person.

9. The registry system of claim 1, wherein the application further has instructions to prevent children from creating a gift register.

10. A method for creating a gift register, comprising;
creating a wish list that includes:
one or more items selected by the first person; and
a first identifying code;
storing the wish list on a storage device;
transmitting the wish list to the second person upon a command by the first person;
creating a gift register that includes:
one or more items selected from the wish list by the second person; and
one or more pieces of identifying information supplied by the second person;
storing the gift register on the storage device; and
maintaining a searchable database that enables third parties to access:
the wish list by providing the first identifying code; and
the gift register by providing a sufficient amount of the identifying information.

11. The method of claim 10, further comprising:
providing a website having a plurality of selectable items.

12. The method of claim 10, further comprising:
automatically deleting the wish list from the storage device after a predetermined amount of time.

13. The method of claim 10, wherein the wish list is transmitted to the second person by electronic mail.

14. The method of claim 10, wherein the gift register further includes one or more additional items, selected by the second person, which are unrelated to the one or more items included in the wish list.

15. The method of claim 10, wherein the one or more pieces of identifying information include:
one or more pieces of the first person's personal information as provided by the second person; and
a second identifying code that uniquely identifies the gift register.

16. The method of claim 10, wherein the gift register further includes a password selected by the second person, and whereby the searchable database only provides access to third parties that provide the password.

17. The method of claim 10, further comprising:
preventing children from creating a gift register.

18. A registry system, comprising:
an application on a storage device including instructions to:
maintain a searchable database having:
a wish list for a first person, created by the first person, including:
one or more items the first person would like to receive from one or more purchasers; and
a first code, generated by the application during creation of the wish list, that uniquely identifies the wish list;
a gift register for the first person, created and managed by a second person, that includes:
one or more items the second person would like the first person to receive from one or more purchasers; and
one or more pieces of identifying information; and
provide a first mode that enables the importation of items included in the wish list into the gift register; and
a processor to execute the instructions.

19. The registry system of claim 18, wherein the instructions are executable via the internet.

20. The registry system of claim 18, wherein the one or more pieces of identifying information includes:
one or more pieces of the first person's personal information as provided by the second person; and
a second code, generated by the application during creation of the gift register, that uniquely identifies the gift register.

21. The registry system of claim 18, wherein the searchable database has a plurality of gift registers, and the application further includes instructions to:
provide a second mode that:
prompts a purchaser to enter one or more pieces of search information;
searches the database for gift registers having identifying information that matches the search information; and
provides the purchaser with access to a matching gift register, provided sufficient search information has been entered by the purchaser to identify a single gift register from the plurality of gift registers.

22. The registry system of claim 21, wherein upon searching the database for gift registers having identifying information that matches the search information, the second mode further:
identifies a plurality of gift registers having identifying information that matches the search information, whereupon the second mode withholds access to any aspect of the plurality of gift registries from the purchaser; and
prompts the purchaser to enter additional pieces of search information.

23. The registry system of claim 21, wherein:
the gift register further includes a password selected by the second person upon creation of the gift register; and
the second mode withholds access to any aspect of a matching gift register until the password is provided by the purchaser.

24. A registry system, comprising;
an application on a storage device including instructions to:
maintain a searchable database having a plurality of gift registers, each:
created and managed by one or more corresponding registrants; and including:
at least one item the one or more corresponding registrants would like to receive from one or more purchasers; and
one or more pieces of identifying information;
provide a first mode that:
prompts a purchaser to enter one or more pieces of search information;
searches the database for gift registers having identifying information that matches the search information; and
provides the purchaser with access to a matching gift register, provided sufficient search information has been entered by the purchaser to uniquely identify a single gift register from the plurality of gift registers; and
a processor to execute the instructions.

25. The registry system of claim 24, wherein the one or more pieces of identifying information includes:
one or more pieces of the corresponding registrant's personal information; and
a code, generated by the application upon creation of the gift register, that uniquely identifies the gift register.

26. The registry system of claim 24, wherein upon searching the database for gift registers having identifying information that matches the search information, the second mode further:
identifies a plurality of gift register having identifying information that matches the search information, whereupon the second mode withholds access to any aspect of the plurality of gift registries from the purchaser; and
prompts the purchaser to enter additional pieces of search information.

27. The registry system of claim 24, wherein:
the gift register further includes a password selected by the second person upon creation of the gift register; and
the second mode withholds access to any aspect of a matching gift register until the password is provided by the purchaser.
